(19) United States
(12) Patent Application Publication
(10) Pub. No.: US 2013/0241389 A1
(43) Pub. Date: Sep. 19, 2013

(54) VACUUM FIELD EMISSION DEVICES AND METHODS OF MAKING SAME

(71) Applicants: Roger A. KISNER, Knoxville, TN (US); Kofi KORSAH, Knoxville, TN (US); John T. SIMPSON, Clinton, TN (US); Alexander M. MELIN, Knoxville, TN (US)

(72) Inventors: Roger A. KISNER, Knoxville, TN (US); Kofi KORSAH, Knoxville, TN (US); John T. SIMPSON, Clinton, TN (US); Alexander M. MELIN, Knoxville, TN (US)

(73) Assignee: UT-BATTELLE, LLC, Oak Ridge, TN (US)

(21) Appl. No.: 13/420,219

(22) Filed: Mar. 14, 2012

(51) Int. Cl. H01J 21/10; H01J 9/26; B82Y 99/00

(52) U.S. Cl. 313/296; 445/44; 977/939

(57) ABSTRACT

A field emission device includes a substrate and a plurality of wires embedded in the substrate. The plurality of wires has at least a field emitter cathode wire; a control grid wire array; and a collector anode array. The field emitter cathode wire, control grid wire array, and collector anode array are embedded in and extend through a nonconductive substrate matrix. A method for making a vacuum field emission device is also disclosed.

### STATEMENT AS TO FEDERALLY SPONSORED RESEARCH

This invention was made with government support under contract No. DE-AC05-00OR22725 awarded by the U.S. Department of Energy. The government has certain rights in this invention.

### FIELD OF THE INVENTION

This invention relates generally to vacuum field emission amplifiers and methods of making vacuum field emission amplifiers.

### BACKGROUND

The nano-fabrication community has been developing vacuum triodes for miniature analog and digital circuit design because of the wide operating temperature range and immunity to radiation damage. The fabrication methods to date have been based on photolithography. An example is Y. M. Wong et al, “Carbon nanotubes field emission integrated triode amplifier array,” Diamond & Related Materials 15 (2006) 1990-1993.

Current state-of-the-art attempts to fabricate robust vacuum nanotriodes is exemplified by the method of Brunetti et al. In this method, fabrication processing starts with a silicon wafer covered by 1 μm of silicon dioxide. This “base” provides the cathode and the insulating layer. Using conventional lithographic techniques, a photo-resist pattern is then imposed on the wafer. The resulting structure is subsequently subjected to wet etching so that only the uncovered silicon oxide is removed down to the silicon substrate. Then, using a second mask alignment, the grid pattern is defined and a 300 nm film of Niobium (a material often used as the grid) is sputtered and lifted-off. After casting a solution of Fe(NO₃)₃.9H₂O in acetone onto the structure, the sample is subjected to the Hot Filament Chemical Vapor Deposition (HFCVD) synthesis process. Typically, during the synthesis process the anodic oxide is reduced to obtain a covering insulating layer on the grid, and a second anodization is performed. The last step consists of a controlled cleaning of the resulting device and a thermal treatment to evaporate residual solvent. The resulting device by Brunetti et al. is shown in FIG. 1.

### SUMMARY OF THE INVENTION

A field emission device includes a substrate and a plurality of wires. A field emitter cathode includes at least one of the wires. A plurality of the wires is separated from the field emitter cathode as a control grid wire array. Another plurality of said wires is separated from the control grid and provides a collector anode array with the control grid interposed between the field emitter cathode and the collector anode array. The wires are embedded in and extend through the substrate, and emerge from the substrate at a device end of the substrate to form the field emitter, control grid, and collector anode.

Electrical connections can be secured to the wires at a connection end of the substrate. The substrate can be cylindrical. The substrate can have a long axis and the wires can be parallel to the long axis. The wires can be configured to form at least one selected from the group consisting of an amplifier, oscillator, diode, triode, tetrode, and pentode. The field emitter cathode can include a pointed tip. The field emission can have a screen grid wire array, and possibly also a third grid wire array. The collector anode array wires can be fused together to form a ring. The substrate can be glass. The field emitter cathode can include a wire array.

The wires can be from 50 nm to 200 μm in diameter. The wires can be from 5 μm to 30 μm in diameter. The wires can be from 10 μm to 25 μm in diameter. The field emitter cathode can include a wire array, and the wire array can be 25-75 μm in diameter. The grid array can be 50-100 μm in diameter. The distance from the center of the field emitter cathode to the outer surface of the collector anode can be 50-250 μm. The height of the field emitter cathode can be 100-200 μm, control grid can be 500-900 μm, and collector anode can be 200-500 μm. The distance from the center of the field emitter cathode to the control grid can be 15-150 μm.

The wire can be a metal. The field emitter cathode can be metal coated glass. The wires can include at least one selected from the group consisting of tungsten, platinum, iridium, a platinum-iridium alloy, stainless steel, carbon nanotubes and combinations thereof.

The field emitter cathode can include a bent tip. The field emitter cathode can include a wire array, each wire have a bent tip, the axis of the tip being directed laterally outward.

The field emission device can have an overall device size of less than 100 μM. A plurality of the field emission devices can be provided in a single contiguous substrate matrix, the matrix containing at least 1,000,000 devices per sq centimeter. The field emission device can include a hermetic vacuum enclosure enclosing at least the field emitter cathode, control grid, and collector anode. The field emission device can include at least property-modifying glass tube which contains a property-modifying substance therewithin, the property-modifying substance modifying at least one property of the field emission device. A plurality of the field emission devices can be connected as a logic circuit.

A method for making a field emission device can include the steps of providing a plurality of glass coated wires; bundling a plurality of the coated wires, the plurality of wires including a center field emitter cathode, a control grid wire array, and a collector anode collector array; heating the bundled coated wires to fuse the tube material coating the wires and create a fused substrate with the field emitter cathode, control grid, and collector anode embedded therein; and cutting the fused substrate.

A vacuum can be applied during the heating step. The bundled wires can be enclosed within an outer hermetic enclosure, and a vacuum applied to the bundled wires within the enclosure. The bundling step can include bundling at least one glass tube which contains a property-modifying substance therewithin, the property-modifying substance modifying at least one property of the field emission device.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a schematic depiction of a prior art carbon nanotube-based triode fabrication that is based on conventional lithographic techniques.

FIG. 2 are SEM images of a (a) glass/tungsten wire array; (b) sharpened tungsten wire field emitters; and (c) a glass cone array.

FIG. 3 are schematic depictions of (a) glass coated wire; (b) coated wire in triode configuration; and (c) triode wire configuration drawn tighter.

FIG. 4 is a schematic (a) plan view and (b) side elevation of a glass fiber vacuum nanotube in a triode configuration.

FIG. 5 is a schematic (a) plan view and (b) side elevation of a glass fiber vacuum nanotube in a tetrode configuration.

FIG. 6 is a schematic (a) plan view and (b) cross section of a glass fiber vacuum nanotube in a triode configuration with a solid collector ring.

FIG. 7 is a schematic (a) plan view and (b) cross section of a glass fiber vacuum nanotube in a tetrode configuration with a solid collector ring.

FIG. 8 is a schematic diagram of a nanotube with a pointed cathode.

FIG. 9 is a schematic diagram of a nanotube with a glass cone cathode.

FIG. 10 is a magnified SEM image of a glass cathode top surface.

FIG. 11 is a schematic depiction of an array of devices fabricated in a single draw.

FIG. 12 is a circuit diagram of a triode according to the invention. The circuit also shows grid biasing and anode load resistors.

FIG. 13 illustrates field trajectories for triode model with positive grid (Cathode voltage=0V; Grid voltage=+8V; Anode voltage=20V).

FIG. 14 illustrates field trajectories for triode model, with negative grid (Cathode voltage=0V; grid voltage=−8V; Anode voltage=20V).

FIG. 15 is a graph of the trans-conductance of triode-like structure compared with linear relationship. Quiescent anode current at zero grid voltage is 475 microamps.

FIG. 16 is a schematic drawing illustrating a method for making vacuum field emission devices according to the invention.

FIG. 17 is a schematic cross section and plan view of a vacuum field emission device with an angled emitter.

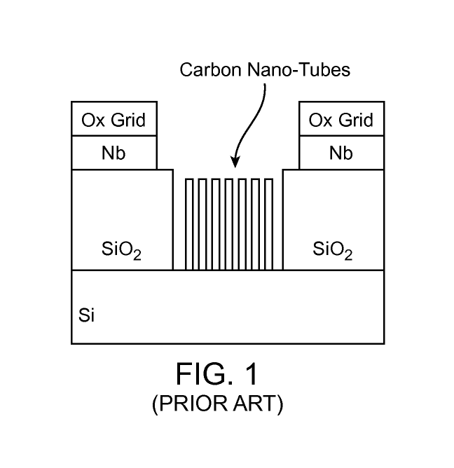

### DETAILED DESCRIPTION OF THE INVENTION

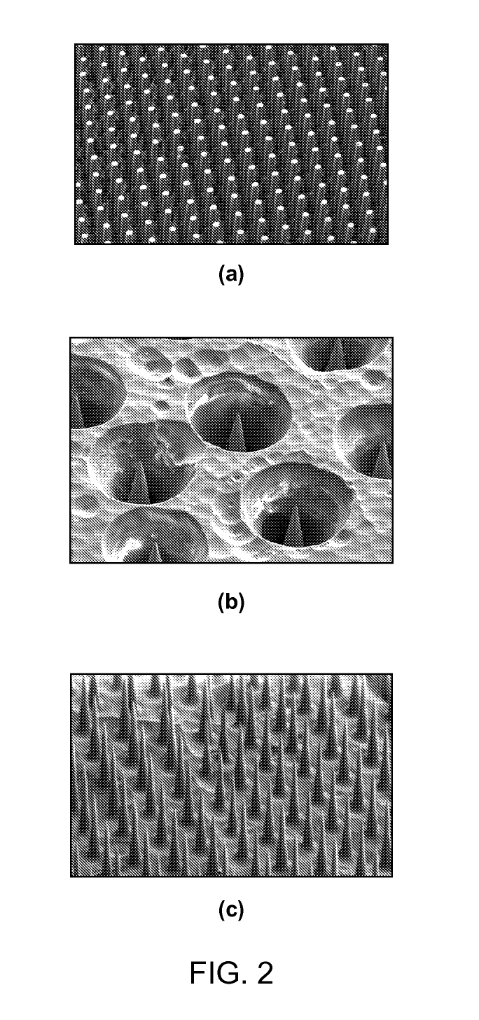

The invention provides a method for fabricating field emission devices such as vacuum field emission amplifiers. The method permits diode, triode, tetrode, pentode, and other gate configurations to be made. Arrays of large numbers of devices can be made on a single substrate. There is shown in FIG. 2 scanning electron microscope (SEM) images of a) a glass/tungsten wire array; b) sharpened tungsten wire field emitters; and c) a glass cone array. The invention produces field emission devices by combining glass-coated wires and fusing them together such that the wires are embedded in a glass matrix and in a suitable configuration for the field emission device that is being formed. The glass-coated wires can be arranged prior to the fusing step in many different ways to produce different devices having different properties. Different wire materials, wire dimensions, wires spacing, and wire locations are all possible to vary each device, which can be easily customized for a particular device. Several different devices can be easily formed in a single processing step, and included in a single resulting wafer. Additional materials can be incorporated into the field emission devices by adding such materials into glass tubes and incorporating them into the bundle, or by bundling wires or small rods of such material into the bundle prior to fusion.

Field emission devices according to the invention include a substrate and a plurality of wires embedded in the substrate. The wires are configured and embedded in the substrate so as to provide at least a field emitter cathode, a control grid and a collector anode. At least one wire provides the field emitter cathode. A plurality of the wires are positioned in the substrate a distance from the field emitter cathode so as to form a collector anode. Another plurality of wires are interposed between the field emitter cathode and the collector anode to provide a control grid. The wires are embedded in and extend through the substrate, emerging from the substrate at a device end of the substrate to form the field emitter, control grid, and collector anode.

The glass coated wires can be produced by any suitable method. In one such method, a fiber-optic glass drawing tower is utilized. This method is more fully described in a U.S. patent application Ser. No. ______ titled “Electrically Isolated High Melting Point Metal Wire Arrays and Method of Making Same”, filed on even date herewith. The disclosure of this application is incorporated fully by reference. Components that can be used to produce field emission devices according to the invention include arrays of glass cones, micro-channel glass, and micro-wire and nano-wire arrays. By using these glass-drawing fabrication techniques, arrays of field emitting triode-like devices can be produced.

The material used to form the substrate can vary. In one aspect, this material is glass. The material must be capable of fusion to form an integrated substrate material into which the wires are embedded. The substrate should have a low viscosity at the drawing temperature. A low viscosity helps “wet” the metal. Also, the sealing glass should have a coefficient of thermal expansion (CTE) that is relatively close to that of the metal being coated, preferably ΔCTE<1-5×10⁻⁷/° C. Examples of suitable substrate glasses include Corning Pyrex, Schott 8330, Schott Fiolax, and soda-lime glasses. The substrate material can be non-conductive. Other suitable materials include other glasses, metals (including alloys), ceramics, polymers, resins, and the like. If a drawing process is used, the substrate material should be drawable, should adhere to or “wet” the metal, and should not adversely react with the metal. Polymers suitable for use should be thermoplastic. Thermoset materials can also be used, but generally cannot be redrawn. Quartz and industrial sapphire can also be used. Choices of materials can have an effect on properties of the product, such as, for example, chemical resistance, ease and/or need of coating, strength, toughness, flexibility, elasticity, and plasticity.

The wires may be made of refractory materials such as tungsten. Other suitable metals include platinum, iridium, a platinum-iridium alloy, stainless steel, or another metal, and combinations thereof. The metal should preferably have a melting point above the glass transition point (softening point) of the substrate material. Almost any conductive material can be used for the wire. Wire materials with melting points above the substrate glass transition temperature can be treated as refractory metal wires. Materials that melt at much lower temperatures than the substrate glass transition temperature would be processed the same way as eutectic metals are processed. Materials that soften at temperatures close to the glass transmission temperature are drawable with the substrate material, and can be processed by drawing, bundling, and fusion processes. Carbon nanotubes can also be a suitable conducting material for the wires.

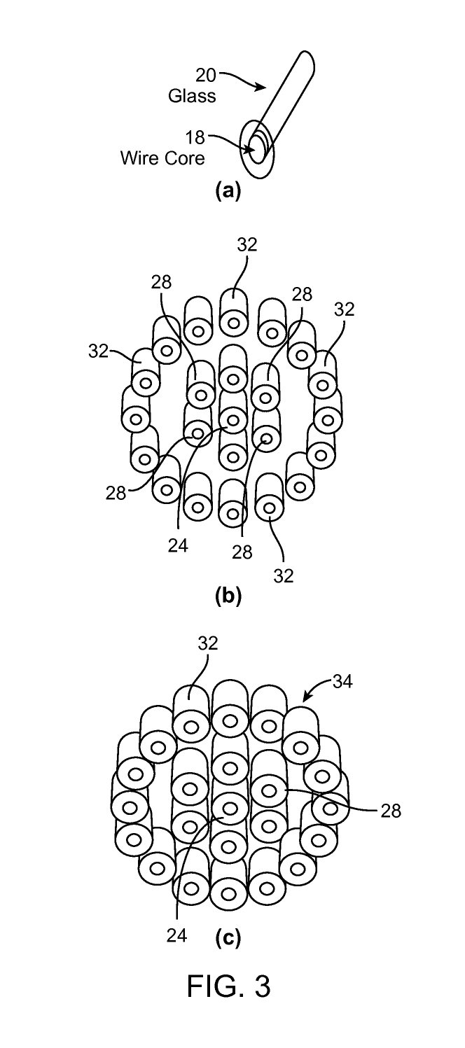

Wire coating can be accomplished by simultaneously drawing glass capillary tubes while pulling spooled metal wires through the capillary tubes during drawing to produce a glass coated wire fiber. A wire 18 with a glass-coating 20 is shown in FIG. 3(a). The drawn fiber can be cut into segments during the drawing process automatically, or as part of a separate operation. The result is a series of straight glass-fiber segments each having a wire core. The glass-coated wire segments are then bundled into a suitable configuration for the device being made. Bundling of the segments can then take place in which a circularly symmetric pattern or any other desired pattern is formed, for example with one fiber in the center surrounded by concentric rings. These can include a center wire 24 or a plurality of such wires forming the field emitter cathode, inner concentric ring 28 for the control grid, and outer concentric ring 32 for the collector anode such as that shown in FIG. 3(b). A smaller, closer packed wire 34 configuration such as shown in FIG. 3(c) is possible by changing the arrangement of wires in the bundle. Wider spacing can be accomplished by the use of wire segments with a thicker glass coating, or by bundling solid glass tubes or rods which have no wire and will fuse and further separate the embedded wires by the desired distance. A closer packed configuration can be accomplished by using glass coated wire segments with a thinner glass coating or including bare wires into the bundle. Other configurations are possible.

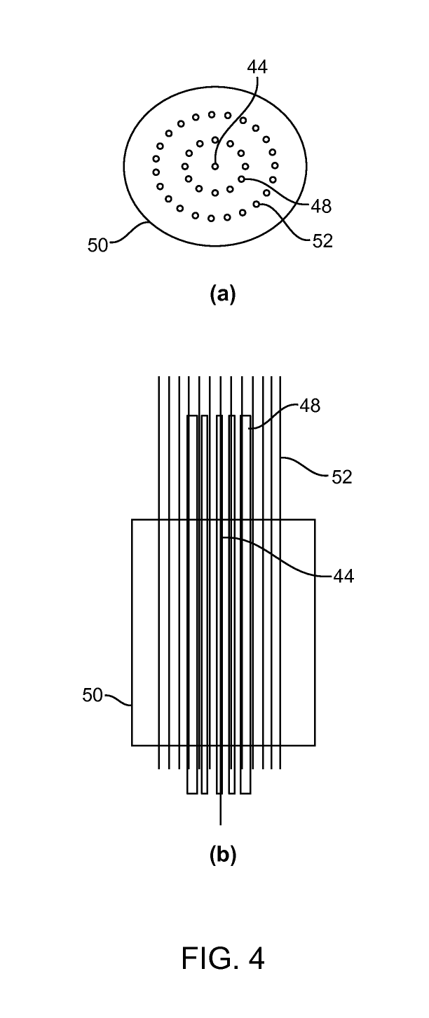

As shown in FIG. 4 the configuration can be arranged so as to provide a triode with a emitter cathode wire 44, a circular array of wires forming a control grid 48, and another circular array of wires that forms the anode collector 52, in a substrate 50. The array that forms the control grid 48 is laterally outward from the cathode emitter 44, and the array which forms the collector anode 52 is laterally outward from the control grid array 48. The wires are embedded in an extend through the substrate, emerging from the substrate at a device end to form the emitter cathode 44, control grid 48, and collector anode 52. The wires can extend through the substrate essentially parallel to one another. The control grid need not be a closed circle. Other configurations are possible. For example, in one embodiment the grid can be configured as a semi circle, or an arc, of rods. This may be done to modify or enhance a particular parametric characteristic such as, for example, inter-electrode capacitance and transconductance for a specific triode application. The closer the wire spacing, the more capacitance the circuit has (for a given type of glass substrate) and the smaller the applied voltage needs to be in order to control the current. Capacitance between electrodes directly affects the upper frequency roll-off of the amplifier. Larger capacitance values lower upper operating frequency because of the low pass filter formed by effective resistance of the field emission channel and inner-electrode capacitance. In addition, stray inductance and inner-electrode capacitance can form tuned circuits that may introduce unwanted resonances. Capacitance is determined by the dielectric constant, effective area, and inverse distance. For that portion of electrode exposed to vacuum (whether cathode, grid, or anode), only distance and surface area affect capacitance since the dielectric constant of vacuum is unity. For those parts of electrodes passing through glass, ceramic, or other insulator material, the constant is much higher. The dielectric constant for glass can range between 3 and 6 for example. To minimize the capacitance added by the insulator section of the amplifier, the insulator can be modified to have voids which averages the dielectric constant. Voids can be introduced in several ways such as using spacer materials between glass that are chemically removed after the amplifier is formed. Voids may also be introduced as bubbles in the glass tubes and rods.

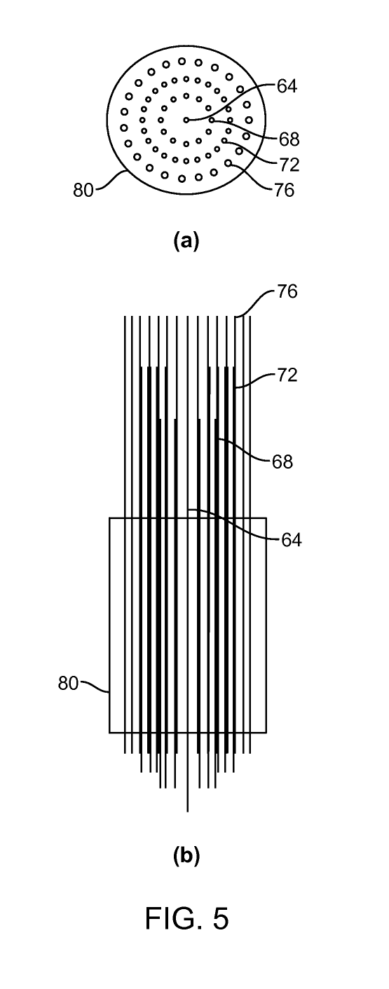

As shown in FIG. 5, the configuration can be arranged so as to provide a tetrode with a center cathode wire 64, a circular array of wires forming a control grid 68, and another circular array of wires that forms a screen grid 72, and an outer wire array 76 that forms the anode collector, in a substrate 80. The same techniques as described above can be used to make higher-order field-emission valve devices such as pentodes and pentagrid converters. As with the triode, the grids for these higher order devices may be semi-circular or the wires may be irregularly spaced but concentric, to achieve a desired performance characteristic.

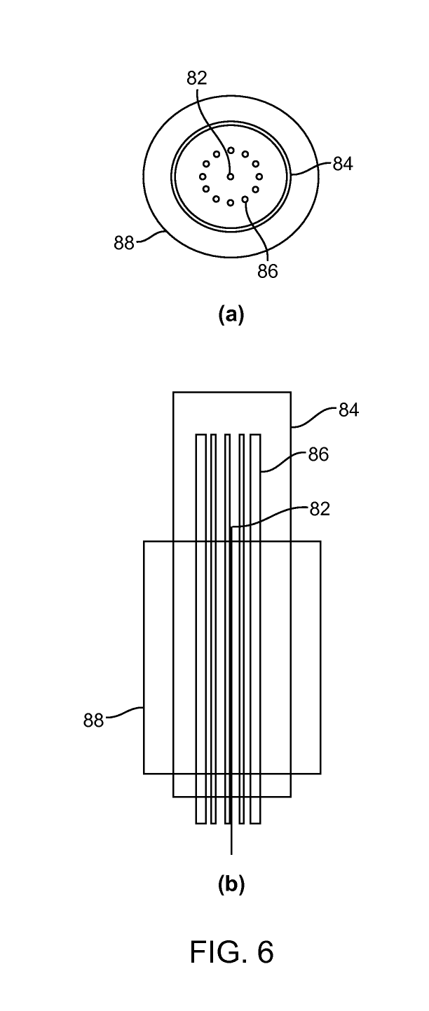

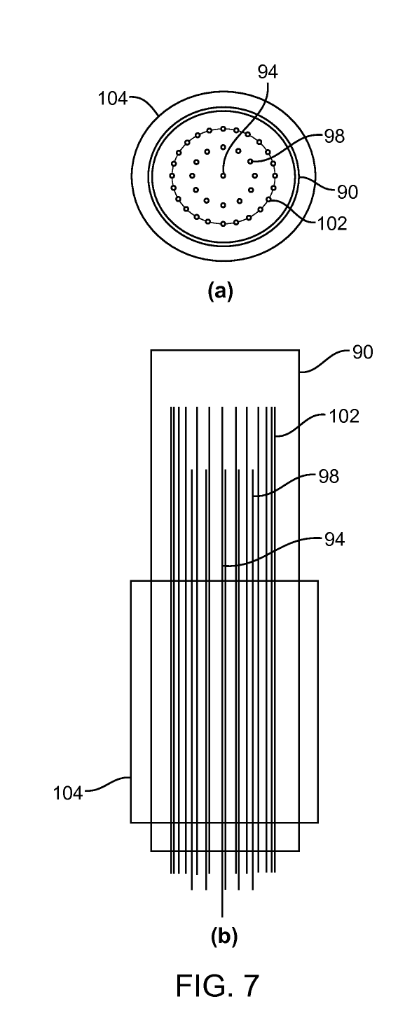

The collector anode can be made from a tight array of wires or alternatively from a continuous metallic ring, as shown in FIGS. 6 and 7. The continuous ring may be formed using a low melting point material that is melted during the drawing procedure The low temperature ring (or sleeve) will only affect the high temperature characteristics of the finished device if the operating temperature of the device is high enough to melt the ring (or sleeve). These low temperature metals are relatively resistant to relatively high temperatures (˜1000 F), but not as high as many refractory metals which can withstand temperatures over ˜3000 F. The round continuous ring configuration could improve the collection of electrons emitted from the cathode. In FIG. 6 there is shown a device with a solid collector anode 84, a field emitter cathode 82 and a control grid 86, in a substrate 88. Similarly there is shown in FIG. 7 a tetrode having a solid ring collector anode 90, together with a field emitter cathode 94, control grid 98, and screen grid 102 in a substrate 104.

The wire is not drawn during the glass coating process as the softening temperature of the wire material is above that of the glass and is not reached during the drawing process. The final diameter of the wire is therefore the same as the diameter of the original wire. The images shown in FIG. 2 show wires with diameters of 75 microns. Wire with diameters as small as 5 μm are commercially available, and other sizes are also possible if available or if made. Similarly to the ring anode, the wire can be made from a eutectic metal so that it can be drawn to a smaller diameter as the substrate is drawn. Eutectic metals allow the electrodes to melt and stretch with the glass. They can therefore be formed into shapes other than wires or rods.

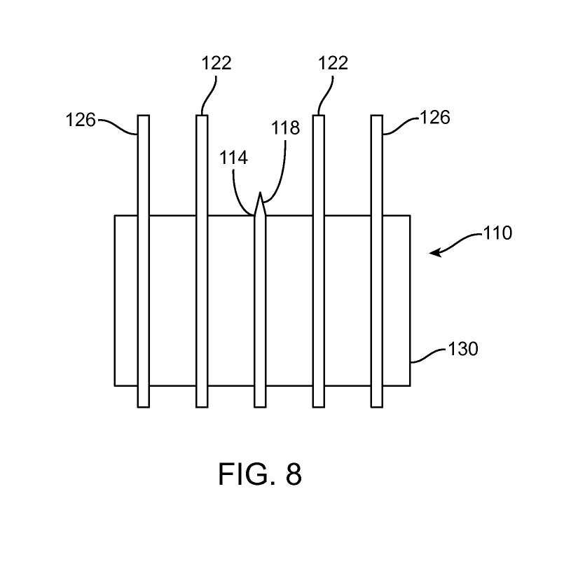

The fused glass is cut to separate devices from the draw. The glass can be etched away to expose the wires. The field emitter cathode can be electrochemically etched to lower the tip to near the glass layer and polish the tip to a small radius for focusing the electric field vectors. A triode device 110 is illustrated in FIG. 8, and has a field emitter cathode 114 with an exposed, sharpened tip 118. A control grid array 122 and collector anode array 126 can also be embedded in the substrate glass 130. The etching can be accomplished by placing a voltage potential on the center wire (in each bundle structure) and electrical-chemical etching the structure. The center wires will be etched and sharpened while the non-activated wires remain unaffected. There is the potential for mechanically sharpening the cathodes. This is normally a problem for other devices such as field emission microscopes that use field emission tips due to the need for a uniform emission pattern. With the generation of electrons at low emission current, mechanical sharpening such as by shear cutting the wire is viable.

The fused bundles now have a sharpened field-emitter cathode 118 surrounded by a ring of metal wires forming the control grid 122, surrounded by a second ring of metal wires forming the collector anode 126. The metal wires forming these components can be electrically connected by any suitable method to provide a functioning field emission device.

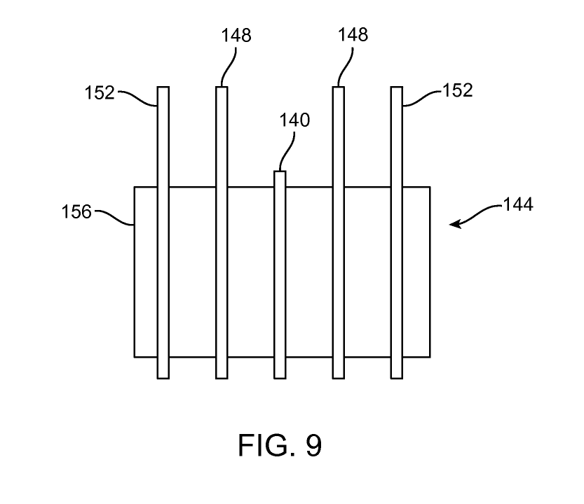

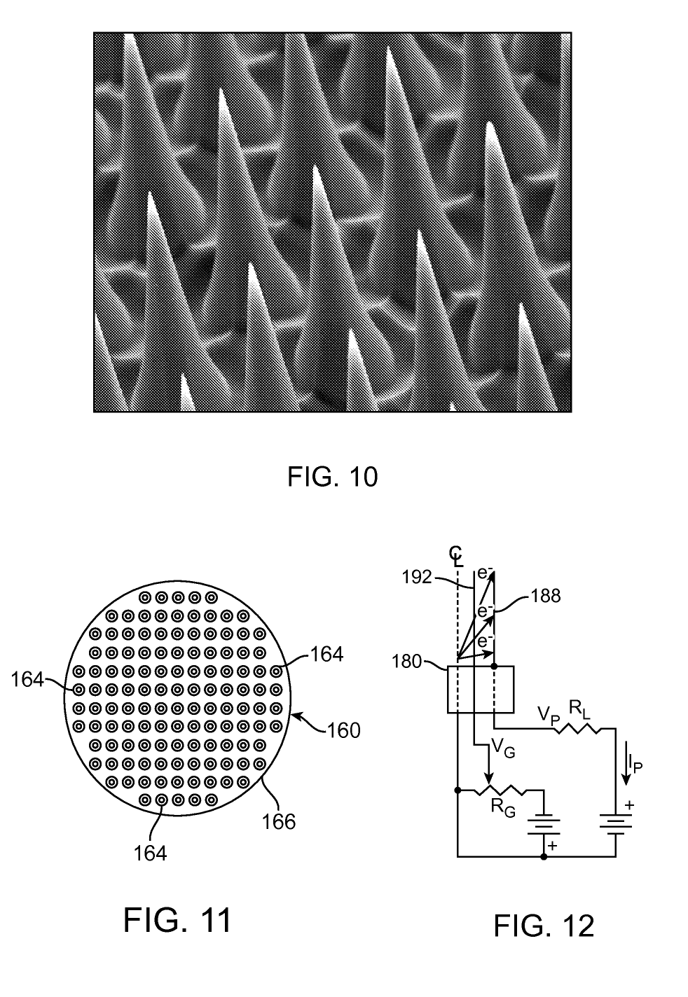

The field emitter cathode can alternatively be formed by a metal coated micro-glass-cone structure, as shown in FIG. 9. An array of extremely sharp cones can be produced and used as a field emitter cathode 140 for the field emission device 144. An SEM image of such glass cones is shown in FIG. 10. The fibers may be bundled as before except the center fiber 140 in each fiber bundle includes this metalized (conductive) cone array. A control grid array 148 and collector anode array 152 can also be embedded in the substrate 156. This alternative cathode fabrication method permits creation of a multi-field emission source for each triode bundle and eliminates an electrical-chemical etching step.

The fabrication process is extendable to high commercial production volumes. Very high packing densities of the devices are possible, which makes complex circuitry possible in a small footprint. Many field-emission devices according to the invention may be fabricated in parallel. Therefore, densities of thousands of devices per square cm may be achievable. The size of the wafer is only limited by how much fiber is bundled before fusion. For example, FIG. 11 shows a device 160 with an array of many triodes 164 in a single substrate 166.

The physical size of the field-emission device can be adjusted by varying the wire diameter and electrode spacing. Devices sizes with diameters of less than 100 μm are attainable. For 5 μm wire diameter, a triode may be less than 50 μm diameter. For smaller wire sizes, device diameters such as 25 μm or smaller are possible. The field emission device can have wires from 50 nm to 200 μm in diameter, from 1 μm to 50 μm in diameter, from 5 μm to 30 μm in diameter, or from 10 μm to 25 μm in diameter. The field emitter cathode can be a wire array that is between 25-75 μm in diameter. The grid array can be between 50-100 μm in diameter. The distance from the center of the field emitter cathode to the outer surface of the collector anode can be about 50-250 μm. The field emission device can have a distance from the center of the field emitter cathode to the center of the control grid of about 15-150 μm. The height of the field emitter cathode can be 100-200 μm, the height of the control grid can be 500-900 μm, and the height of the collector anode can be 200-500 μm.

For wire sizes of about 25 μm, overall device sizes of about 100 μm or less can be obtained, depending on the electrode spacing. Table 1 below shows that for triodes of 50 μm diameter a theoretical maximum of more than 40,000 devices can be packed per square cm using a hexagonal packing structure. For 10 μm devices, packing exceeds 1,000,000 devices per square cm.

TABLE 1
Potential vacuum triode packing densities (per square cm.)

| Device Diameter | | Packing | Test Area | |
|---|---|---|---|---|
| (m) | Area | Factor | (m²) | Quantity |
| 1.0E−05 | 7.9E−11 | 0.91 | 0.0001 | 1.2E+06 |
| 2.5E−05 | 4.9E−10 | 0.91 | 0.0001 | 1.9E+05 |
| 5.0E−05 | 2.0E−09 | 0.91 | 0.0001 | 4.6E+04 |
| 1.0E−04 | 7.9E−09 | 0.91 | 0.0001 | 1.2E+04 |

As an alternative to the cold-cathode (field emission) devices described above, a thermionic emission version of the glass-fiber fabricated device is also possible. By including two centrally located wires in close proximity (as a cathode), a filament structure can be fabricated. Several means of creating a functioning heater are possible: (1) etching to reduce the diameter of the exposed tungsten wires then welding or twisting their ends, where the decreased wire diameter would increase electrical resistance and form a heater; and (2) a preformed filament can be tacked between the two central wires. Other methods may be possible. An electron vacuum tube circuit can be formed using both field-emission and thermionic-emission devices contained on the same substrate.

Although the field-emission devices can operate at vacuums of 10⁻⁶ Torr, experimental data suggest that lower operating pressures are needed for low noise performance. Bake-out and high vacuum techniques would be needed to achieve pressures less than 10⁻⁷ Torr. Production devices would require gettering that would be similar to that used in commercial vacuum tubes of the mid twentieth century. Performance of the devices is enhanced by high vacuum, and standard techniques and constructions for producing devices in high vacuum enclosures can be utilized. Pressures of at least 10⁻⁹ can be achieved in such devices.

The field emission devices can include at least one property-modifying substance to modify one or more characteristics of the field emission device. The property-modifying substance can be provided in a glass tube which contains the property-modifying substance there within, and which is bundled with the glass coated wires prior to fusing. Alternatively, the property-modifying substance could be provided as a solid rod which is bundled with the glass coated wires and thereby fused and embedded in the substrate.

Vacuum field emission devices according to the invention could have utility in any device where vacuum field emission devices are used. For example, the field emission devices could be used in electronics and computer processors. The devices could enable exa-flop computing speeds through high density device packaging (1 billion devices per chip) and ultra-fast clocking rates (100 GHz to 1 THz). An amplifier-gate based on vacuum field emission can be replicated at micro and nano scales to form large arrays of electronic circuits. Circuits formed by vacuum emission devices made according to the invention can have both linear amplification characteristics like their vacuum tube counterparts, but also can act as fast binary switches such as field-effect transistors do. Therefore the vacuum emission devices of the invention can be the building blocks for computer processors using them as switches. The gain can be made sufficient to create good switching action. In addition, by intentionally increasing inner-electrode capacitance, it becomes feasible to make binary memory devices out of vacuum field emission devices.

The unique characteristics of these circuits are operation at high frequencies (beyond that of semiconductors), high temperatures (500° C.), and in high-radiation environments (no doped semiconductors). Such devices could thus find wide application in several scientific fields including: 1) supercomputers (CPUs requiring less cooling that run at clock speeds 100 times faster than current CMOS technology); 2) hardened electronics (harsh environment applications including Generation IV nuclear power plants and fusion reactor systems (high radiation and temperature), military platforms (high temperatures and size/weight constraints), and space-based systems (high radiation and low payload); 3) sensors (devices and systems with embedded electronic components required to perform in high radiation and temperature environments,

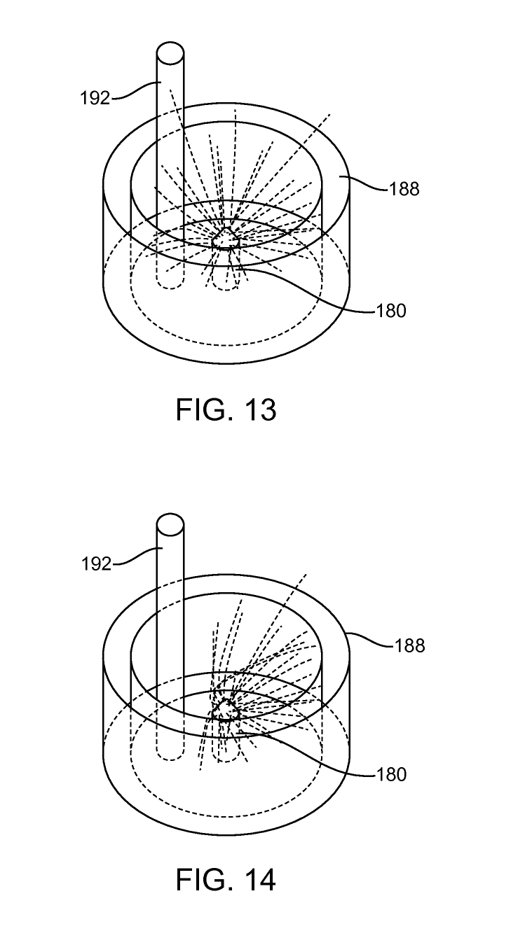

The operation of a device according to the invention was modeled and such a device is shown in FIG. 12-14. A simple triode configuration having the circuit configuration shown in FIG. 12 and the schematic construction shown in FIGS. 13-14 was developed. The behavior of this theoretical device was simulated using Lorentz-E software (Integrated Engineering Software, 220-1821 Wellington Avenue, Winnipeg, Manitoba R3H 0G4 Canada).

The model has a central solid cylindrical cathode, a solid cylindrical grid, and a hollow cylindrical anode surrounding both the cathode and the grid as shown in FIGS. 13 and 14. Electrons are attracted to the collector anode because of its positive potential with respect to the emitter cathode. As shown in FIGS. 13-14, electrons traveling from the emitter cathode 180 to the collector anode 188 pass through the electric field set up by the control grid 192. The height of the collector anode 188 and control grid 192 is much greater than that of the cathode emitter 180. The control grid potential acts to shield the anode charge and thus proportion the electron current to the anode according to the potential between grid and cathode emitter. This control of the current flow by grid potential forms the basis of the triode's operation.

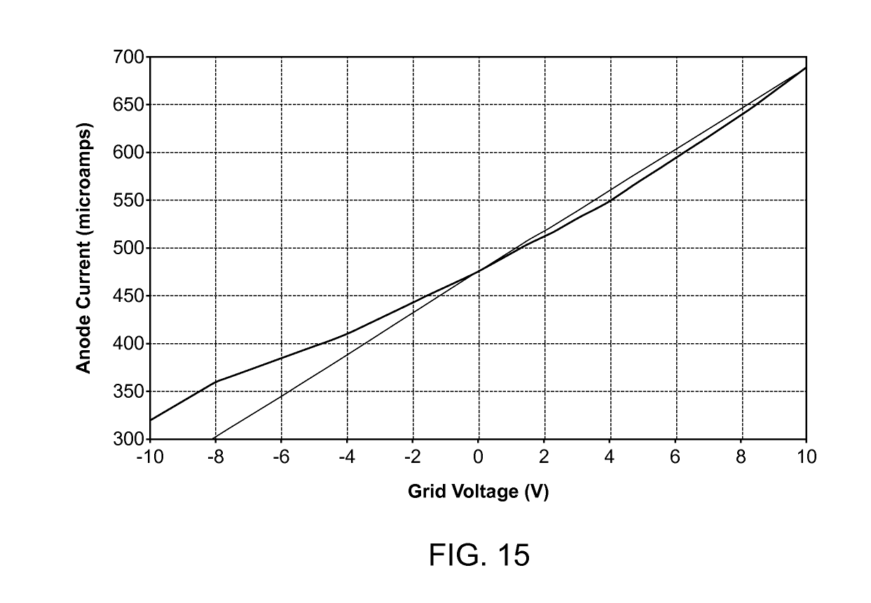

In each of FIGS. 13-14, the cathode and the grid wires are each 50 μm in diameter. The distance from the center of the cathode to the outer surface of the anode is 226 μm. The heights of the cathode 180, grid 192, and anode 188 are 175 μm, 700 μm, and 350 μm, respectively. The distance from the center of the cathode 180 to the center of the grid 192 is 100 μm. The figures show electron trajectories for different applied grid voltage but the same cathode and anode voltages. In particular, the cathode and anode voltages in both figures are 0V and +20V respectively. However, the grid voltage for FIG. 13 is +8V, while the grid voltage for FIG. 14 is −8V. The negative grid voltage repels more electrons from the surface of the collecting anode (a significant number of the trajectories go up and away from the surface of the collector anode), while for the positive grid voltage, more electrons reach the surface of the collector anode. The anode current for various grid voltages (same cathode and anode voltage of 0V and 20V respectively) was obtained in order to obtain sufficient data points to plot a graph of grid voltage versus anode current. FIG. 15 shows the results which indicate reasonable linearity. The trans-conductance is 21.6 micromhos.

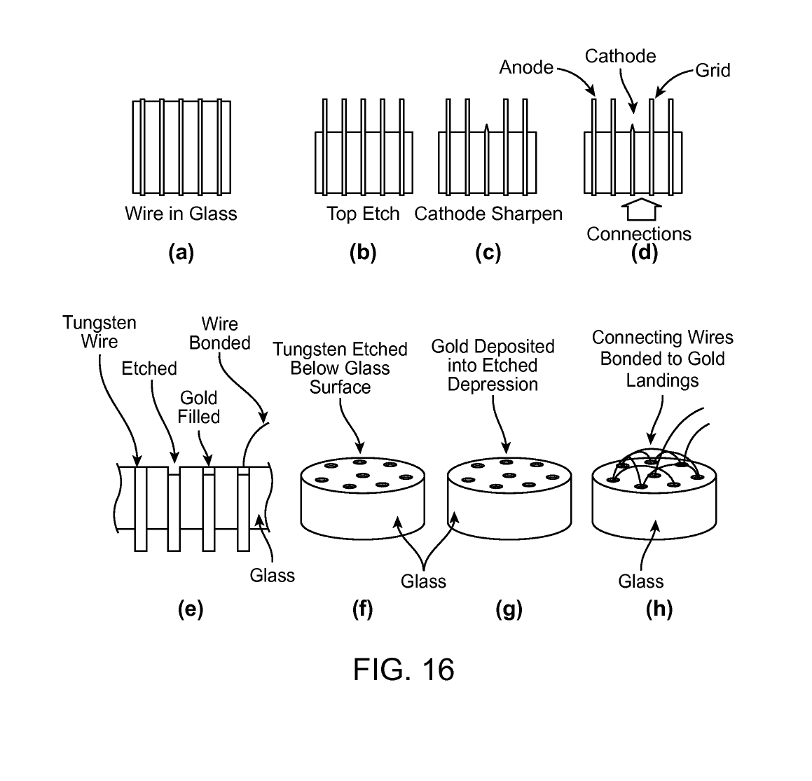

The invention can be utilized with fabrication techniques suitable for mass production. One such process is shown in FIG. 16. This process first uses a modified “Taylor wiredrawing” technique to glass coat non-drawable, high melting point wire. This produces glass coated wire fibers. Other methods of producing glass coated wires can be utilized. These fibers are then bundled together and fused into a solid rod. The rod is cut into wafers as shown in FIG. 16(a). After etching away part of the glass matrix at a device end of the wafer, the wire array becomes fully exposed as shown in FIG. 16(b). The center field emitter can be electrochemically etched or otherwise sharpened to lower the tip to near the glass layer and polish the tip to a small radius for focusing the electric field vectors as illustrated in FIG. 16(c). This etching can be accomplished by placing a voltage potential on the center wire (in each bundle structure) and electrical-chemical etching the structure. The center wires will be etched and sharpened while the non-activated wires remain unaffected. The fused bundles now have a sharpened field emitter cathode surrounded by a ring of metal wires forming a control grid, surrounded by a second ring of metal wires forming the collector anode. The metal wires forming the control grid are typically to be electrically connected. The same is true for the metal wires forming the collector anode. However, using multiple wires to form the anode and control grid allow many alternative device configurations such as multiple control grids and anodes per emitter.

After fabricating arrays of diode and triode devices, the emitter cathodes, control grids, and collector anodes must be electrically connected prior to testing under ultra-high vacuum conditions. Since the wires extend all the way through the wafer, energizing or sensing the electrode is accomplished by simply connecting to it via the back plane. Device and other component wiring connections can be made at the structure's back or bottom by semiconductor wire bonding or by a 2D version of a zebra connection style pad and connector strip. Any suitable connection method is possible.

The following steps can be used to fabricate connections at a connection end of the wafer: (1) etch tungsten wires to below the glass surface as shown in FIG. 16(e)-(f), (2) deposit gold into the etched depression bringing the gold to the glass surface as shown in FIG. 16(g), (3) polish the resulting surface, and (4) wire bond all collector anode wires together and all control grid wires together and bring out electrical connections to all three tube electrodes (cathode, grid, and anode), as shown in FIG. 16(h). Interconnects to other electronics to build integrated devices can be provided by suitable techniques, for example, by masking and physical vapor deposition techniques on the connection side of the substrate.

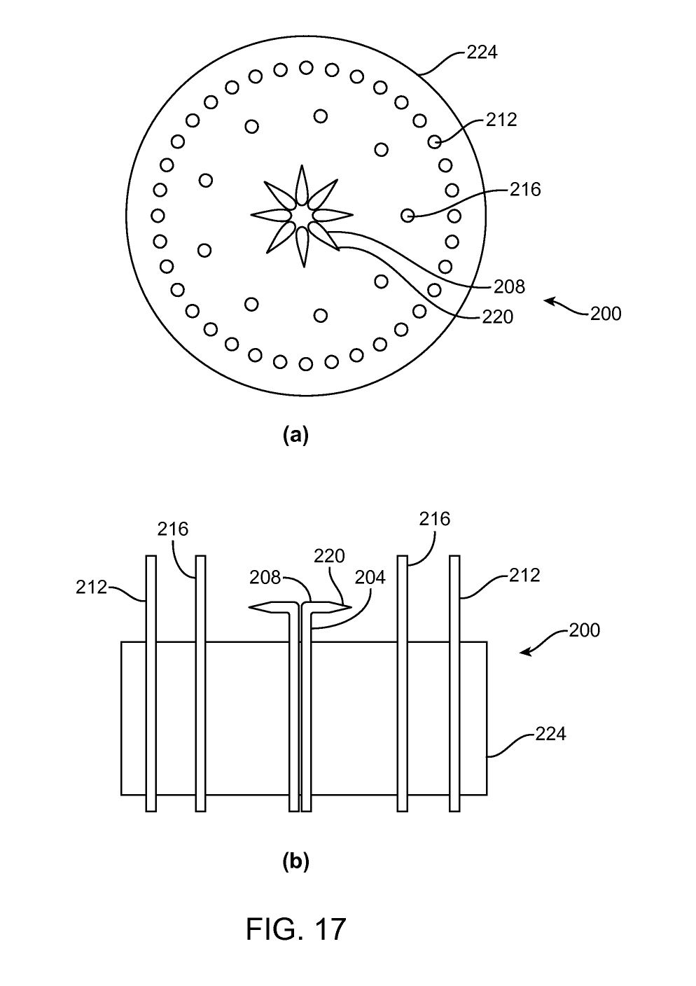

There is shown in FIG. 17 an alternative embodiment in a triode configuration 200 in which the emitter cathode 204 has a tip 208 that is bent relative to the long axis of the emitter cathode so as to be directed at the collector anode array 212 and control grid array 216. The amount of bending can vary depending on the device design but can be between 45 and 135 degrees from the long axis in one aspect. Depending on the bundling process, multiple wires can be placed in the center and each center wire can then be bent outward at different angles to create multiple devices. Optionally the anodes, cathodes and grid wires for the multiple devices can be connected to make one circular or non-circular device with multiple cathodes and the center each facing in different radial directions. The tip 208 can have a sharpened or pointed end 220 to enhance the field emission characteristics of the emitter cathode 204. As shown in FIG. 17(a), the pointed ends 220 of each wire in the emitter cathode array 204 can be directed radially outward so as to point in the direction of and radially adjacent part of the collector anode array 212 and control grid 216. The assembly can be embedded in a suitable substrate 224.

The devices and methods of the invention permit diode, triode, tetrode, pentode, and other gate configurations to be made. The devices are capable of operating at high temperatures (greater than 500 C) and in high radiation environments. Arrays of large numbers of devices can be made on a single substrate. The fabrication process is extendable to high commercial production volumes. Very high packing densities are possible, which makes complex circuitry possible in a small footprint. The resulting vacuum device structures are oriented horizontally rather than vertically (as with photolithographic approaches), which has several advantages.

Eutectic metals permit the wires to melt and stretch with the glass, and can be formed into shapes other than wires or rods. Structures such as electron beam-forming devices can be made. Resonant chambers can be formed in the diode, triode, or other device. In this manner, RF, microwave, and very short wavelength amplifiers can be made such as Class C amplifiers.

By the application of a static magnetic field, a magnetron oscillator/amplifier can be constructed. By paralleling many vacuum field emission devices, high power can be developed at microwave and millimeter wave frequencies. The micro vacuum field emission device may also be utilized to construct sensors.

The foregoing description of the preferred embodiments of the invention has been presented for purposes of illustration. The invention is not limited to the embodiments disclosed. Modifications and variations to the disclosed embodiments are possible and within the scope of the invention.

1. A field emission device, comprising a substrate and a plurality of wires, a field emitter cathode comprising at least one of said wires; a plurality of the wires being separated from the field emitter cathode as a control grid wire array; and another plurality of said wires being separated from the control grid and providing a collector anode array with the control grid interposed between the field emitter cathode and the collector anode array, the wires being embedded in and extending through the substrate, and emerging from the substrate at a device end of the substrate to form the field emitter, control grid, and collector anode.

2. The field emission device of claim 1, wherein electrical connections are secured to the wires at a connection end of the substrate.

3. The field emission device of claim 1, wherein the substrate is cylindrical.

4. The field emission device of claim 3, wherein the substrate has a long axis and the wires are parallel to the long axis.

5. The field emission device of claim 1, wherein the wires are configured to form at least one selected from the group consisting of an amplifier, oscillator, diode, triode, tetrode, and pentode.

6. The field emission device of claim 1, where the field emitter cathode comprises a pointed tip.

7. The field emission device of claim 1, further comprising a screen grid wire array.

8. The field emission device of claim 1, further comprising a third grid wire array.

9. The field emission device of claim 1, wherein said collector anode array wires are fused together to form a ring.

10. The field emission device of claim 1, wherein the substrate is glass.

11. The field emission device of claim 1, wherein the field emitter cathode comprises a wire array.

12. The field emission device of claim 1, wherein the wires are from 50 nm to 200 μm in diameter.

13. The field emission device of claim 1, wherein the wires are from 5 μm to 30 μm in diameter.

14. The field emission device of claim 1, wherein the wires are from 10 μm to 25 μm in diameter.

15. The field emission device of claim 1 wherein the field emitter cathode comprises a wire array, and the wire array is 25-75 μm in diameter.

16. The field emission device of claim 1, wherein the grid array is 50-100 μm in diameter.

17. The field emission device of claim 1, wherein the distance from the center of the field emitter cathode to the outer surface of the collector anode is 50-250 μm.

18. The field emission device of claim 1, wherein the height of the field emitter cathode is 100-200 μm, control grid is 500-900 μm, and collector anode is 200-500 μm.

19. The field emission device of claim 1, wherein the distance from the center of the field emitter cathode to the control grid is 15-150 μm.

20. The field emission device of claim 1, where the wire is a metal.

21. The field emission device of claim 1, wherein the field emitter cathode is metal coated glass.

22. The field emission device of claim 1, where said wires comprise at least one selected from the group consisting of tungsten, platinum, iridium, a platinum-iridium alloy, stainless steel, carbon nanotubes and combinations thereof.

23. The field emission device of claim 1, wherein the field emitter cathode comprises a bent tip.

24. The field emission device of claim 1, wherein the field emitter cathode comprises a wire array, each wire have a bent tip, the axis of the tip being directed laterally outward.

25. The field emission device of claim 1 wherein the overall device size is less than 100 μm.

26. The field emission device of claim 1, wherein a plurality of the field emission devices are provided in a single contiguous substrate matrix, the matrix containing at least 1,000,000 devices per sq centimeter.

27. The field emission device of claim 1 further comprising a hermetic vacuum enclosure enclosing the field emitter cathode, control grid, and collector anode.

28. The field emission device of claim 1, further comprising at least property-modifying glass tube which contains a property-modifying substance therewithin, the property-modifying substance modifying at least one property of the field emission device.

29. The field emission device of claim 1, wherein a plurality of such devices are connected as a logic circuit.

30. The field emission device of claim 1, wherein the cathode comprises at least two wires that are electrically connected to provide resistance heating.

31. A method for making a field emission device, comprising the steps of
providing a plurality of glass coated wires;
bundling a plurality of the coated wires, said plurality of wires comprising a center field emitter cathode; a control grid wire array; and a collector anode collector array;
heating the bundled coated wires to fuse the tube material coating the wires and create a fused substrate with the field emitter cathode, control grid, and collector anode embedded therein;
cutting the fused substrate.

32. The method of claim 31, wherein vacuum is applied during the heating step.

33. The method of claim 31, further comprising the step of enclosing the bundled wires within an outer hermetic enclosure, and applying a vacuum to the bundled wires within the enclosure.

34. The method of claim 31, wherein the bundling step comprises bundling at least one glass tube which contains a property-modifying substance therewithin, the property-modifying substance modifying at least one property of the field emission device.
